(19) United States
(12) Patent Application Publication
(10) Pub. No.: US 2020/0236902 A1
(43) Pub. Date: Jul. 30, 2020

(54) WATER TREATMENT APPARATUS AND METHOD

(71) Applicant: GRIEGER INVESTMENTS PTY LTD, Banyo, Queensland (AU)

(72) Inventor: Chris GRIEGER, Banyo, Queensland (AU)

(21) Appl. No.: 16/650,176

(22) PCT Filed: Sep. 25, 2018
(86) PCT No.: PCT/AU2018/000186

§ 371 Date: Mar. 24, 2020

(30) Foreign Application Priority Data
Sep. 25, 2017 (AU) 2017903890

(51) Int. Cl. A01K 7/02; C02F 1/34; B01D 35/027

(52) U.S. Cl. CPC A01K 7/025; C02F 1/34; C02F 2201/009; C02F 2303/04; B01D 35/027

(57) ABSTRACT

An apparatus for the treatment of drinking water contained in a vessel is disclosed. The apparatus comprises a housing, a drinking water inlet and a drinking water outlet. The apparatus also includes a pump operable to pump drinking water from the water inlet to the water outlet, wherein the water outlet and pump are configured to dispense drinking water generally upwards from the water outlet below a surface of the drinking water to cause a continuing disturbance in a surface of the drinking water contained in the vessel. In one example, the apparatus is used to reduce algae in the water. In another example, the apparatus is used to increase the oxygen content in the water.

### PRIORITY DOCUMENTS

The present application claims priority from Australian Provisional Patent Application No. 2017903890 titled “WATER TREATMENT APPARATUS AND METHOD” and filed on 25 Sep. 2017, the content of which is hereby incorporated by reference in its entirety.

### TECHNICAL FIELD

The present disclosure relates to the provision of drinking water. In a particular form, the present disclosure relates to the treatment of drinking water for livestock.

### BACKGROUND

An important requirement in the management of livestock such as cattle and sheep is the provision of suitable drinking water. Typically the water will be provided to the animals in a drinking trough which is generally an elongate body having a channel for receiving the drinking water. The water source for the drinking trough may be from any one of multiple sources such as mains water, bore water, river water or water from a dam. In the case where there is no mains pressure, there will be some pumping arrangement to pump water from the water source to a holding tank. In remote locations this pumping arrangement may be powered by wind or solar power. Water is then typically gravity fed to the drinking troughs.

The quality of the water provided to the animals is an important issue as poor quality will often affect the health of animals drinking the water and in the case of livestock could significantly affect their value. Water troughs or indeed any drinking vessel are susceptible to the growth of algae which not only can clog the trough but in some instances may be toxic to animals. One approach to dealing with algae is by chemical treatment of the water using an algaecide. In one example, copper sulphate is used as an algaecide in the form of solid blocks which are placed in the drinking vessel and which gradually dissolve over a period of weeks. In this way, copper in solution will be introduced into the water supply which then kills the algae.

Unfortunately, use of copper sulphate has a number of significant disadvantages including potential copper toxicity to animals and further the continuing need to replenish the copper sulphate blocks. There is also the potential for increased corrosion of metal components. Other chemicals may be used such as chlorine compounds but again these may be toxic to animals when used in the incorrect concentrations and will require continuous replenishment which will be especially difficult on large cattle or sheep stations.

### SUMMARY

In a first aspect, the present disclosure provides an apparatus for the treatment of drinking water contained in a vessel, comprising:

a housing;

a drinking water inlet;

a drinking water outlet; and

a pump operable to pump drinking water from the water inlet to the water outlet, wherein the water outlet and pump are configured to dispense drinking water generally upwards from the water outlet below a surface of the drinking water to cause a continuing disturbance in a surface of the drinking water contained in the vessel.

In another form, the apparatus is submerged beneath the surface of the drinking water.

In another form, the continuing disturbance in the water surface is localised about the drinking water outlet.

In another form, the continuing disturbance in water surface is an undulation in the water surface formed substantially over the surface of the drinking water contained in the vessel.

In another form, the undulation in the water surface is a standing wave resulting from the interaction of the disturbance in the water surface and the boundary of the vessel.

In another form, the apparatus includes a filter to filter drinking water entering the drinking water inlet.

In another form, the pump is a submersible electric pump.

In another form, the submersible electric pump is solar powered.

In another form, the apparatus is configured to be located on a floor section of the vessel.

In another form, the apparatus is integrated with the vessel.

In another form, the drinking water inlet of the water treatment apparatus receives water directly from the water source for the drinking vessel.

In another form, the drinking water contained in the vessel is treated to reduce algae.

In another form, the drinking water contained in the vessel is treated to increase its oxygen content.

In another form, the water surface breaks the surface tension of the water surface.

In another form, the apparatus further includes a water aeration arrangement to increase the oxygen content of the drinking water dispensed from the drinking water outlet relative to the drinking water entering the drinking water inlet.

In another form, the water aeration arrangement includes a venturi fitting located between the drinking water inlet and the drinking water outlet.

In a second aspect the present disclosure provides a method for treating drinking water contained in a vessel, comprising:

pumping drinking water from the drinking water generally upwards from below a surface of the drinking water to cause a continuing disturbance in a surface of the drinking water contained in the vessel.

In another form, the continuing disturbance in water surface is an undulation in the water surface formed substantially over the surface of the drinking water contained in the vessel.

In another form, the undulation in the water surface is a standing wave resulting from the interaction of the disturbance in the water surface and the boundary of the vessel.

In another form, the drinking water contained in the vessel is treated to reduce algae.

In another form, the drinking water contained in the vessel is treated to increase its oxygen content.

In another form, the disturbance in the water surface breaks the surface tension of the water surface.

In another form, the method further includes aerating the water to increase the oxygen content of the drinking water dispensed from the drinking water outlet relative to the drinking water entering the drinking water inlet.

In a third aspect, the present disclosure provides a livestock watering station comprising:

a source of drinking water; and

one or more vessels connected to the source of drinking water, the one or more vessels including a water treatment apparatus in accordance with the first aspect of the present disclosure.

### BRIEF DESCRIPTION OF DRAWINGS

Embodiments of the present disclosure will be discussed with reference to the accompanying drawings wherein:

FIG. 1 is a side sectional figurative view of a drinking vessel incorporating a water treatment apparatus in accordance with an illustrative embodiment;

FIG. 2 is a side sectional figurative view of the drinking vessel illustrated in FIG. 1 depicting the water treatment apparatus causing a continuing disturbance in the water surface according to an illustrative embodiment;

FIG. 3 is a side sectional figurative view of the drinking vessel illustrated in FIG. 1 depicting the water treatment apparatus causing a continuing disturbance in the water surface according to a further illustrative embodiment;

FIG. 4 is a side sectional figurative view of the drinking vessel illustrated in FIG. 1 depicting the water treatment apparatus causing a continuing disturbance in the water surface according to another illustrative embodiment;

FIG. 5 is an exploded perspective view of a water treatment apparatus in accordance with another illustrative embodiment;

FIG. 6 is an assembled perspective view of the water treatment apparatus illustrated in FIG. 5;

FIG. 7 is a side sectional figurative view of a drinking vessel incorporating the water treatment apparatus illustrated in FIG. 5;

FIG. 8 is a front view of a solar power module for a water treatment apparatus in accordance with an illustrative embodiment;

FIG. 9 is a rear view of the solar power module illustrated in FIG. 8;

FIG. 10 is a top view of the solar power module illustrated in FIG. 8;

FIG. 11 is a top perspective view of an unassembled water treatment apparatus in accordance with another illustrative embodiment;

FIG. 12 is a top perspective view of the water treatment apparatus illustrated in FIG. 11 in a first state of partial assembly;

FIG. 13 is a top perspective view of the water treatment apparatus illustrated in FIG. 11 in a second state of partial assembly;

FIG. 14 is a top perspective view of the water treatment apparatus illustrated in FIG. 11 in a third state of partial assembly;

FIG. 15 is a top perspective view of the water treatment apparatus illustrated in FIG. 11 in a fourth state of partial assembly;

FIG. 16 is a top perspective view of the water treatment apparatus illustrated in FIGS. 11 to 15 as assembled; and

FIG. 17 is a livestock watering station comprising a number of drinking vessels incorporating solar power watering treatment apparatus in accordance with an illustrative embodiment.

In the following description, like reference characters designate like or corresponding parts throughout the figures.

### DESCRIPTION OF EMBODIMENTS

Referring now to FIG. 1, there is shown a side sectional view of a drinking vessel 200 incorporating a water treatment apparatus 100 according to an illustrative embodiment. In this illustrative embodiment, vessel 200 is an elongate vessel such as a drinking trough used for supplying drinking water to livestock and the like. Trough 200 consists of a floor section 210 and in this case four sloped side walls 220 forming an elongate rectangular trapezoid configuration. As would be appreciated, drinking troughs are available in many different configurations including those having a semi-cylindrical, triangular or box cross-section. In other embodiments, the drinking vessel may have a cylindrical or multi-sided polygon configuration. The drinking vessel may be self-supporting or include a mounting frame arrangement. Furthermore, the drinking vessel may be made out of any material suitable for containing water including, but not limited to, concrete, plastic, metal (eg, galvanised steel or aluminium), composite materials such as fibreglass and glass reinforced concrete, or wood.

Associated with trough 200 is a water dispensing arrangement 400 consisting of in this embodiment a nozzle connected to a water source such as mains water, bore water, river water or water from a dam. Water dispensing arrangement 400 may involve a water level sensing arrangement such as float valve or electronic sensor to ensure that the drinking water 300 contained in the vessel is filled to an appropriate level.

In this embodiment, water treatment apparatus 100 is submerged beneath the surface of the drinking water 300 contained in trough 200 and consists of a housing 190, drinking water inlet 110, drinking water outlet 120 and a pump 130 located in housing 190 that pumps drinking water from water inlet 110 to the water outlet 120. The water outlet 120 in combination with the pump 130 are configured to dispense drinking water generally upwards from the water outlet 120 below the water surface to cause a continuing disturbance in the water surface 310.

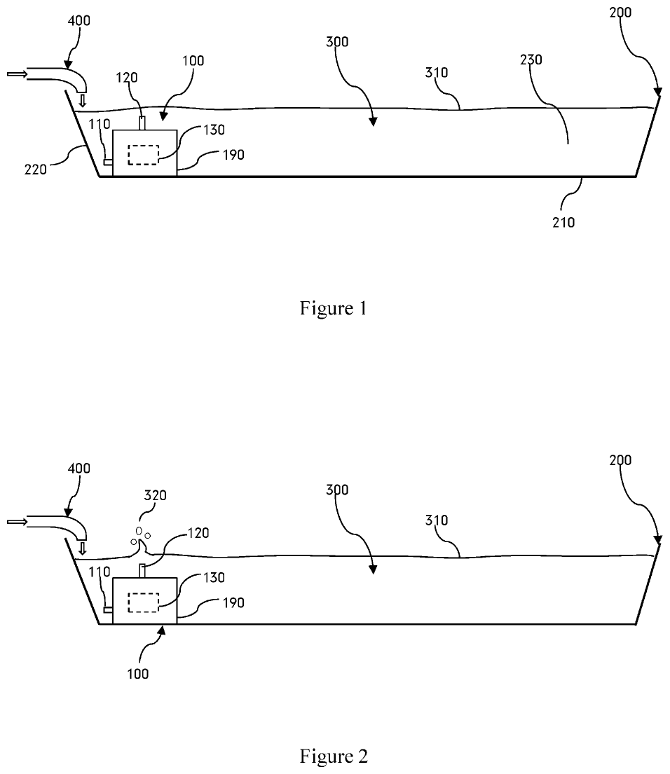

Referring now to FIG. 2, there is shown the water treatment apparatus 100 in operation causing a continuing disturbance in the water surface 310 according to an illustrative embodiment. In this example, the disturbance 320 in the water surface 310 is relatively localised causing a fountain or bubbler type effect. This effect also increases the oxygenation of the water by breaking the surface tension of the drinking water.

The average height of the fountain as compared to the undisturbed surface water level may in different embodiments lie in the ranges of: 0 cm-5 cm, 5 cm-10 cm, 10 cm-15 cm, 15 cm-20 cm, 20 cm-25 cm or greater than 25 cm.

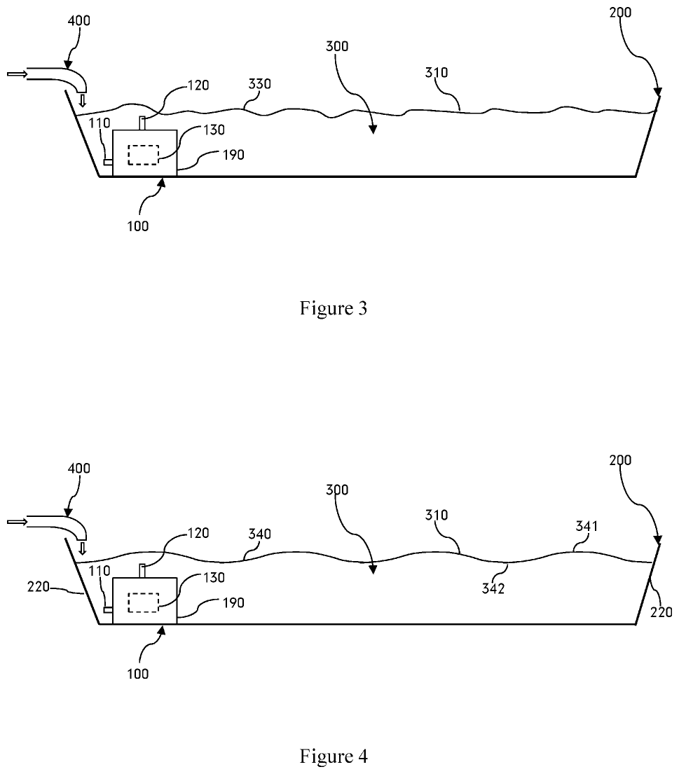

Referring now to FIG. 3, there is shown the water treatment apparatus 100 in operation causing a continuing disturbance in the water surface 310 according to a further illustrative embodiment. In this example, the disturbance is in the form of an undulation 330 in the water surface 310 that is formed substantially over the entire surface 310 of the drinking water in the vessel 200.

The average height of the undulation as compared to the undisturbed surface water level may in different embodiments lie in the ranges of: 0 cm-5 cm, 5 cm-10 cm, 10 cm-15 cm, 15 cm-20 cm, 20 cm-25 cm or greater than 25 cm.

Referring now to FIG. 4, there is shown the water treatment apparatus 100 in operation causing a continuing disturbance in the water surface 310 according to another illustrative embodiment. In this example, the undulation in the water surface 310 is in the form of a standing wave 340 consisting of a regular series of peaks 341 and troughs 342 that results from the interaction of the disturbance in the water surface 310 and the boundary of the vessel 200 which in this case comprises the side walls 220.

As would be appreciated, the standing wave 340 in trough 200 extends along the longitudinal axis of the trough. In other vessel geometries, the standing wave may adopt other configurations. In the example of a circular cross-section tank, a circular standing wave may be formed. In FIGS. 1 to 4, water treatment apparatus 100 is located towards one end of the vessel 200. In other examples, the water treatment apparatus 100 may be located centrally with respect to the dimensions of the vessel 200. As would also be appreciated, the fountain or bubbler arrangement shown in FIG. 2 may also be configured to also generate an undulation that is formed substantially over the surface of the drinking water as shown in FIG. 3, including generating a standing wave as shown in FIG. 4.

The average difference between a peak and a respective trough of the standing wave may in different embodiments lie in the ranges of: 0 cm-5 cm, 5 cm-10 cm, 10 cm-15 cm, 15 cm-20 cm, 20 cm-25 cm or greater than 25 cm.

Water treatment apparatus 100 may be attached to the floor section 210 of the drinking vessel or alternatively may reside at the bottom of the drinking vessel due to its own self-weight. In other embodiments, water treatment apparatus 100 may be attached to the sides or ends of the drinking vessel where the water outlet 120 is then oriented to dispense drinking water generally upwards from the water outlet below the water surface to cause the continuing disturbance in the water surface.

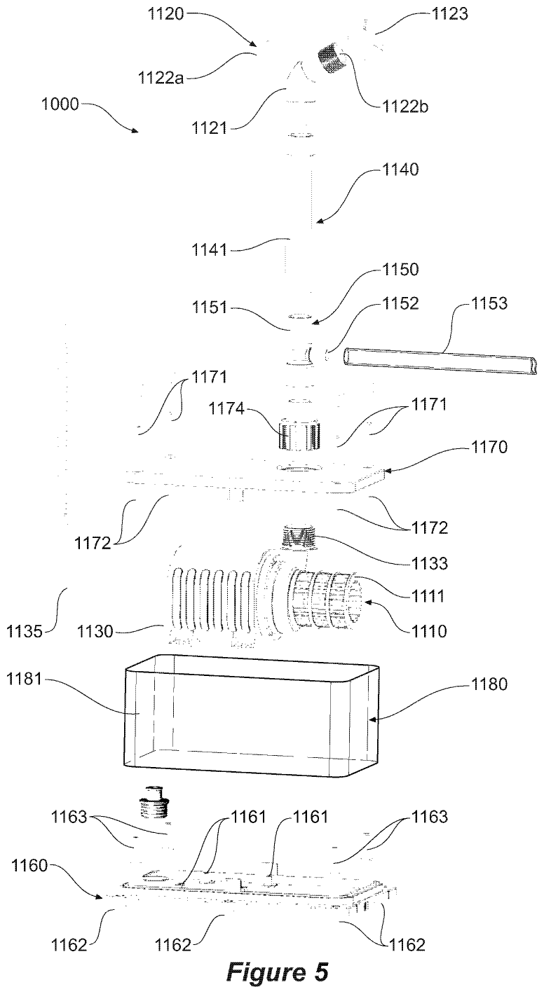

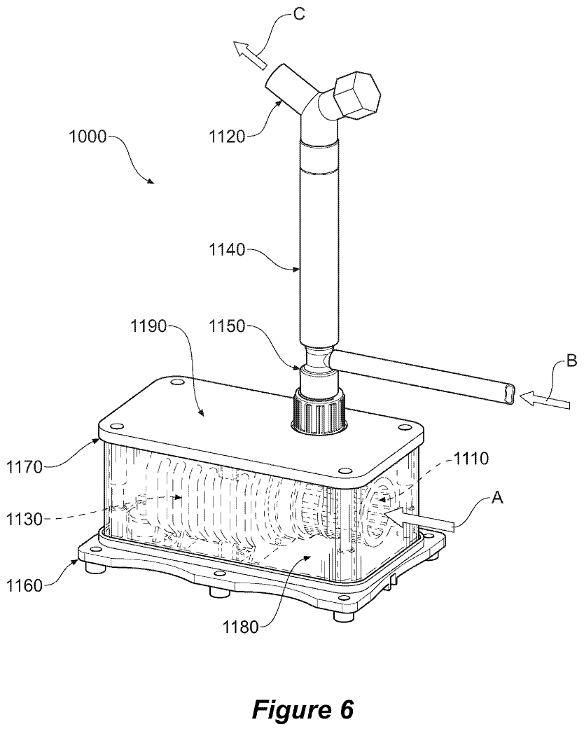

Referring now to FIGS. 5 and 6, there are shown exploded and assemble perspective views of a water treatment apparatus 1000 in accordance with another illustrative embodiment which is configured to be completely immersed in the drinking water of the drinking vessel where it is deployed. Water treatment apparatus consists of a drinking water inlet 1110 configure as a cylindrical inlet, drinking water outlet 1120 and a pump 1130 that pumps drinking water from water inlet 1110 to the water outlet 1120 to dispense drinking water from the water outlet 1120 below the water surface at an angle from the vertical but still generally upwards to cause a continuing disturbance in the water surface.

Pump 1130 in this illustrative embodiment is a submersible electric pump that is powered by electrical cord 1135 and is attached to a rectangular shaped based portion 1160 including attachment locations 1161 to which pump 1130 can be mounted to.

In one example, pump 1130 is a low pressure centrifugal DC brushless pump that may be powered by a solar panel or DC power supply and having a head pressure of approximately 1 metre and a flow rate of approximately 1000 litres/hour. This would be suitable for an elongate trough of lengths varying between 1 metre to 3 metres and widths varying between 200 mm to 800 mm (ie, a water surface area in the range of 0.2 m² to 2.4 m²) and depths varying between 200 mm to 500 mm.

In another example, a larger pump may be employed having a flow rate of approximately 3000 litres/hour which would be suitable for an elongate trough of lengths varying between 3 metres to 6 metres and widths varying between 300 mm to 900 mm (ie, a water surface area in the range of 0.9 m² to 5.4 m²) and depths varying between 300 mm to 1200 mm.

As would be appreciated, the maximum head pressure and flow rate may be adjusted depending on the expected water surface area of the drinking vessel. In the case of a DC brushless pump these characteristics can be adjusted by increasing or decreasing the voltage of the power supply to increase or decrease the head/flow rate respectively.

In this illustrative embodiment, base portion 1160 includes four upwardly extending cylindrical guide members 1163 located on the corners of base portion 1160 which are received within cooperating sleeve members 1172 located on respective corners of top portion 1170 of the water treatment apparatus 1000. In this manner, base portion 1160 may be attached to top portion 1170 by the use of screws 1171 which attach to the cylindrical guide members 1162 at each corner. Base portion 1160 further includes attachment locations 1162 that may be used to attach water treatment apparatus 1000 to the drinking vessel if required.

Extending between the periphery of the base portion 1160 and the top portion 1170 is a filter member 1180 that in this example comprises a wire screen 1181 that together with base and top portions 1160, 1170 forms a rectangular box housing 1190 that contains the pump 1130 (as best seen in FIG. 6).

In this illustrative embodiment, the water inlet 1110 corresponds to the pump inlet located on pump 1130 and includes a cylindrical shaped inlet filter 1111. As water inlet 1110 is within the housing box 1190, filter wall member 1180 acts as a filter to prevent any debris in the drinking water from entering the pump 1130. As would be appreciated, while in this embodiment filter member 1180 is implemented as a wire screen 1181, filter member 1180 may comprise any suitable arrangement that functions to filter the drinking water such as any appropriate flexible or rigid mesh.

In this example, water outlet 1120 comprises a Y-shaped tubed member 1121 having two exit orifices 1122a, 1122b with orifice 1122b having a screw thread arrangement to which a cap 1123 may be attached if required. In another example embodiment, the angle of the arms of Y-shaped tubed member with respect to the vertical direction may be adjusted. Water outlet 1120 is connected to pump outlet 1133 which includes a screw threaded portion that extends through an aperture 1174 in top portion 1170 of housing 1190 by an extension arrangement 1140 including a vertically extending connector pipe or riser 1141. In this manner, the water outlet 1120 may be set at predetermined depth in the drinking vessel in order to generate the required disturbance in the water as described above.

In this illustrative embodiment, water treatment apparatus 1000 includes a further water aeration arrangement 1150 to increase the oxygen content in the water. In this example, aeration arrangement 1150 includes an intermediate venturi fitting 1151 located between the pump outlet 1133 and the water outlet 120 which incorporates a venturi air intake 1152 that is connected to a flexible hose 1153 whose other end (not shown) is placed above the surface of the water in the drinking vessel.

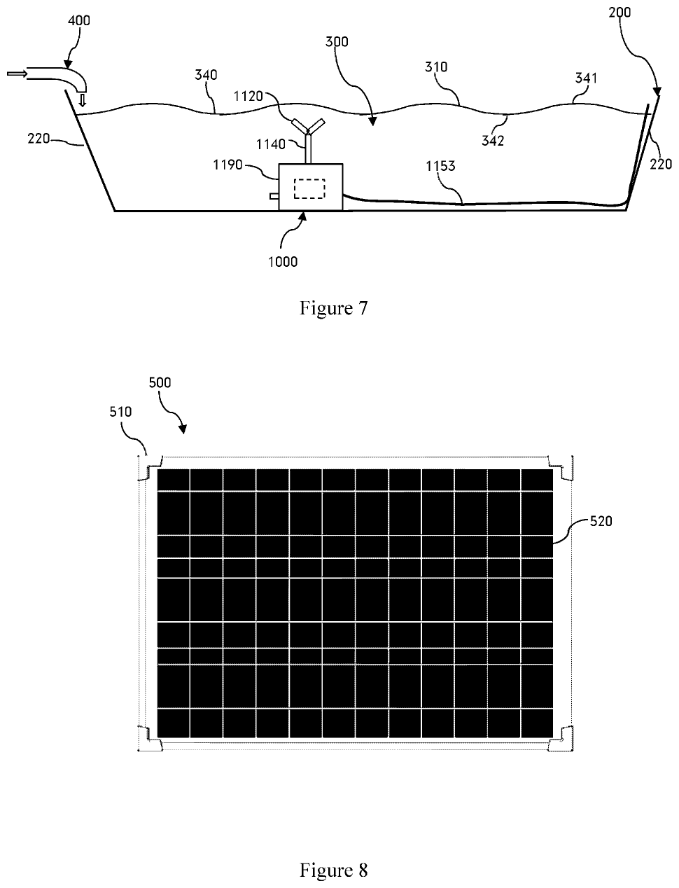

Referring also now to FIG. 7, there is shown water treatment apparatus 1000 in operation where apparatus 1000 is submerged in the vessel 200 below the surface of the water with the drinking water outlet 1120 in this example located just beneath the surface of the drinking water contained in the vessel. As would be appreciated, for different types and depths of drinking vessels different length connector pipes 1141 may be employed as desired.

Pump 1130 functions to pump drinking water entering through the submerged water inlet 1110 (as indicated by arrow A in FIG. 6) which has been filtered by filter wall member 1180 to the water outlet 1120 through connector pipe 1140. In this example, one of the orifices of the drinking water outlet is capped and the water is directed generally upwardly at a 60 degree angle with respect to the vertical in order to generate the undulations in the surface in the water. In other examples, the water may be directed generally upwardly at an angle between: 0 degrees-10 degrees, 10 degrees-20 degrees, 20 degrees-30 degrees, 40 degrees-50 degrees, 50 degrees-60 degrees or 70 degrees-80 degrees with respect to the vertical.

In this illustrative embodiment water being pumped from pump outlet 1133 will draw in air through flexible hose 1153 (as indicated by arrow B) as it passes thought intermediate venturi fitting 1151 before being dispensed from water outlet 1120. As such, the water dispensed from the drinking water outlet 1120 (as indicated by arrow C) will be aerated relative to the drinking water entering the water inlet 110 and as a result contain extra oxygen.

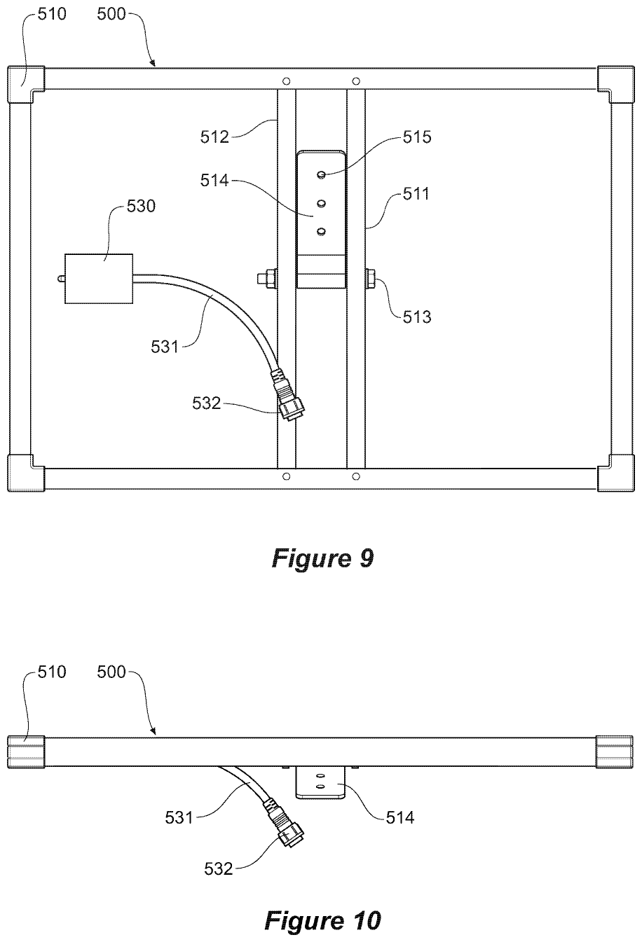

Referring now to FIGS. 8 to 10, there are shown various views of a solar power module 500 for a water treatment apparatus according to an illustrative embodiment. Solar power module 500 in this example includes a rectangular frame surround 510 for mounting the photovoltaic (PV) cell array 520 consisting of 3×12 individual poly crystalline silicon cells having an operating voltage of 18 V and producing a maximum power of in this example 30 Watts. As would be appreciated, the size and capacity of the array may be varied in accordance with the electrical power requirements of the water treatment apparatus.

On the reverse side, frame 510 includes two central spaced apart struts 511, 512 that extend from the top to the bottom of the frame 510. Disposed between struts 511, 512, is a mounting bracket 514 configured as a flat plate member that is pivotably attached to the struts 511, 512 by hinge arrangement 513 and which includes a series of apertures. As a result, the orientation of mounting bracket 514 may be adjusted to position solar power module 500 as required.

Solar power module 500 further includes a power controller 530 and an electrical supply cable 531 and a connector 532 which in use would connect to a complementary connector for the power cord of the electrical pump.

The Applicant has found surprisingly that by applying a continuing disturbance to the water surface of a drinking vessel in the manner described above that this functions to beneficially reduce the growth of algae in the drinking vessel as compared to other vessels which do not include such a water treatment apparatus.

In one example, drinking water was sourced from bore water of relatively low salinity for dispensing to cattle in troughs of 5 metre length located in a stubble paddock. Typically, very high concentrations of algae developed rapidly in these drinking troughs which then required manual cleaning every two days in a labour intensive process.

Following installation of a water treatment apparatus in accordance with the embodiment described in FIGS. 5 and 6, the drinking trough remained substantially clear of algae, only requiring cleaning every 5 days for debris and feed from the cattle. As such, the cleaning frequency is not only reduced but the type of cleaning of the drinking trough is simplified. In another example, the drinking water was sourced from river water which presented the same algae growth problem in the drinking troughs. Use of a water treatment apparatus in accordance with the above described embodiments again substantially reduced the cleaning required by preventing the growth of algae.

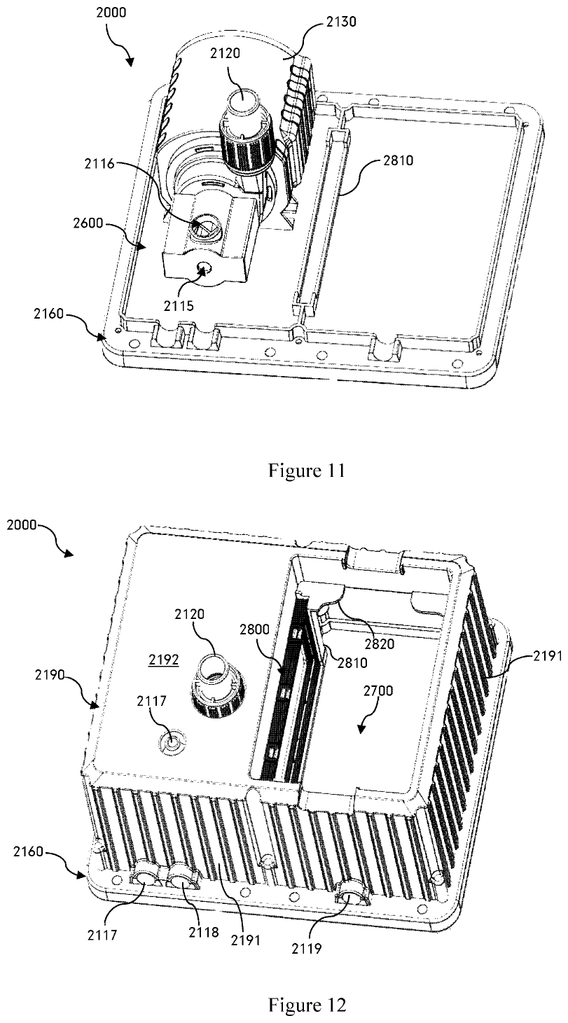

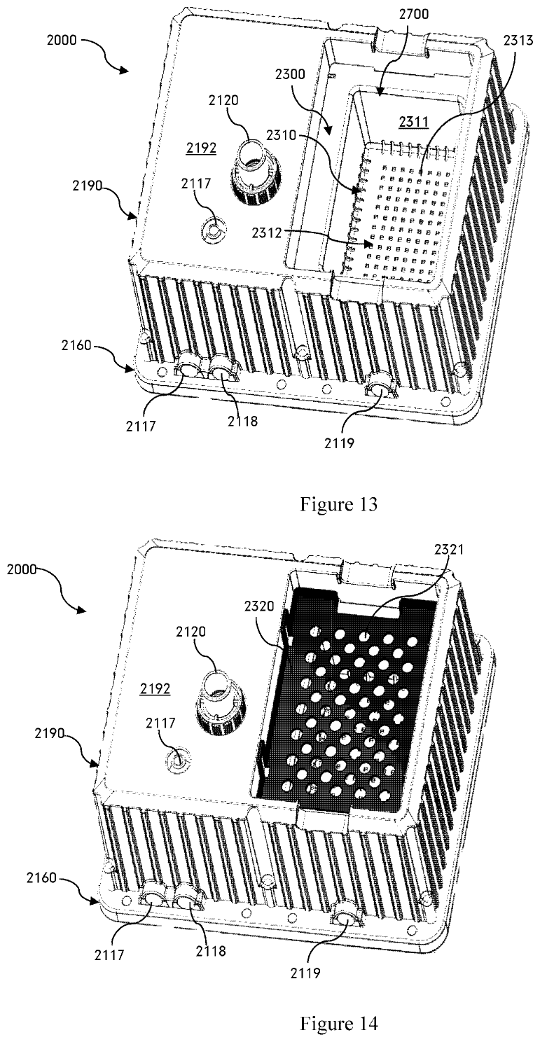

In those examples, where the water treatment apparatus is configured to break the surface tension of the water surface of the drinking vessel and/or a water aeration arrangement is incorporated such as the venturi arrangement referred to above in FIGS. 5 and 6, then the oxygen content of the water is increased relative to a drinking vessel which does not include a water treatment apparatus. This increased oxygenation of the drinking water is believed to improve the taste and provides additional health benefits to the livestock drinking the water from the drinking vessel. Referring now to FIGS. 11 to16, there are shown top perspective views of a water treatment apparatus 2000 in accordance with another illustrative embodiment in successively more assembled configurations. Similar to water treatment apparatus 1000, water treatment apparatus 2000 is configured to be completely immersed in the drinking water of the drinking vessel where it is deployed. In this embodiment, water treatment apparatus 2000 comprises a dual chamber housing arrangement where the first chamber 2600 is for receiving a submersible electric pump 2130 having a pump inlet 2115 and a drinking water outlet 2120 (as shown in FIG. 11) and a second chamber 2700 (as shown in FIG. 12) for receiving or enclosing a material holding arrangement to receive solid material for either dispersal in the drinking water that is output by water treatment apparatus 2000 or to act as filtering medium to reduce water contamination. As would be appreciated, depending on the depth of the water in the drinking vessel, a further upright tube member may be attached to drinking water outlet 2120 if required.

In this example, dual chamber housing arrangement includes an outer housing 2190 having a rectangular box configuration attached to a rectangular base portion 2160. Housing 2190 consists of four side walls 2191 that extend upwardly from base portion 2160 and a part roof portion 2192 that forms a roof over the first chamber 2600 that receives pump 2130 leaving an open portion of the housing 2190 which opens to the second chamber 2700. In this example, pump inlet 2130 also includes an additional venturi aeration arrangement 2116 which on assembly (eg, see FIG. 12) connects to venturi input port 2117 located on roof portion 2192 for connection of a flexible tube (not shown) to convey air from above the water surface of the drinking vessel to the venturi arrangement 2116 to assist in water oxygenation as has been described above.

Between the first and second chambers 2600, 2700 there is defined a filter receiving portion 2810 that receives a removable rectangular shaped filter 2800 which when inserted into filter receiving portion 2810 forms a dividing wall between the first and second chambers 2600, 2700 (as best seen in FIG. 12). In one example, filter 2800 may be a 120 micron mesh filter. In another example, filter 2800 may be a 180 micron mesh filter.

On assembly, a basket member 2300 is inserted into second chamber 2700 and is seated on ledge portions 2820 that extend inwardly from the four corners of the housing 2190 defining the periphery of chamber 2700. Basket member 2300 is of generally rectangular box configuration and includes a material receiving cavity or portion 2310 defined by the four walls 2311 and a floor portion 2312 that includes a regular grid of apertures 2313 to form a supporting sieve or screen element with a gap formed between floor portion 2312 and base portion 2160 of water treatment apparatus 2000. In this manner, the material receiving portion 2310 is able to receive a material that may be originally in tablet or granule form that is to be dissolved or dispersed in the drinking water or alternatively which acts to reduce water contamination as water passes through material receiving portion 2310.

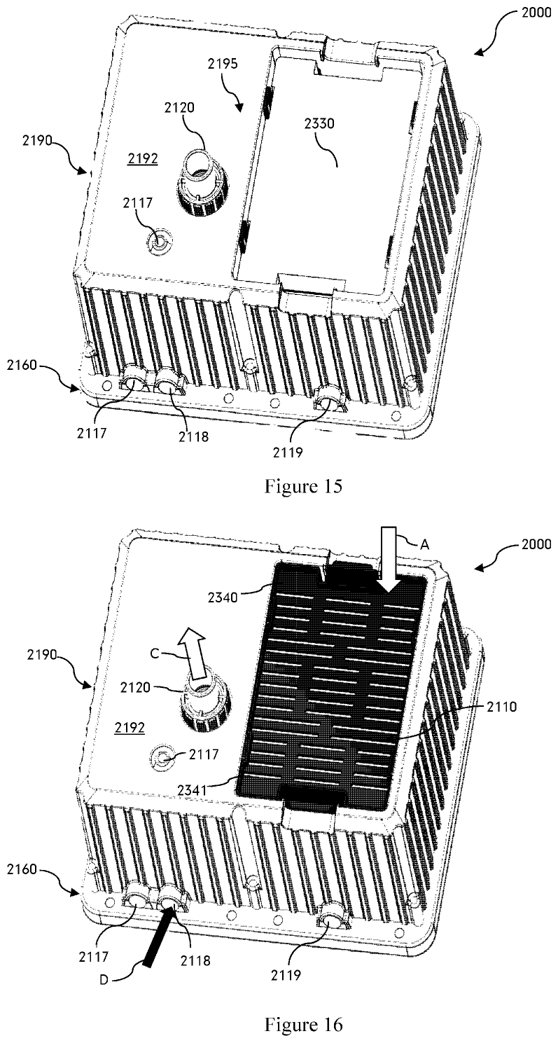

On assembly, a support member 2320, again having a regular grid of apertures 2321, is placed over material receiving portion 2310 (as best seen in FIG. 14). Support member 2320 provides a support surface for foam filter 2330 which functions as a further filtering media (as best seen in FIG. 15). Covering foam filter 2330 is a grate member 2340 having a series of horizontal slots which overlays and retains foam member 2320 and which is attached to the housing 2190 by a snap fit arrangement to in effect form the drinking water inlet 2110 of apparatus 2000.

In this manner, housing 1190 is substantially sealed except for drinking water inlet 2110 which is located to receive drinking water initially into the second chamber 2700. In this example, drinking water inlet 2110 is located at the top of the second cavity chamber 2700, however, other configurations are possible which also allow water to pass through material receiving portion 2310.

On operation of pump 2130 a negative pressure is first created in first chamber 2600 which is sealed in the process creating a negative pressure in the second chamber 2700 through the common filter 2800 which forms a wall between the two chambers 2600, 2700. This negative pressure draws water into second chamber 2700 through drinking water inlet 2110 (as indicated by arrow A in FIG. 16) where it goes through a first stage of filtering due to foam filter 2320, following which it enters material receiving portion 2310 of basket member 2300 via apertures 2321 of support member 2320 and passes through the material located in material receiving portion 2310 of second chamber 2700 and apertures 2313. On exiting basket member 2300, water then passes into the first chamber 2600 through filter 2800 to be pumped out of drinking water outlet 2120 by pump 2130 (as indicated by arrow C in FIG. 16).

In this example, first chamber 2600 includes apertures 2117, 2118 formed in housing 1190. The first aperture 2117 is for a power cord for pump 2130 and the second aperture 2118 may be used to introduce additional material in liquid form to the first chamber 2600 to be pumped out of drinking water outlet 2120. In this manner, additional material may be added directly to drinking water entering the apparatus 2000 as required (as indicated by arrow D in FIG. 16). As would be appreciated, when apertures 2117, 2118 are in use they would be sealed to prevent the direct entry of water into the first chamber 2600 without having first going through foam filter 2330 and second mesh filter 2800. The Applicant has found that the adoption of multiple filtering stages not only enhances the drinking water quality but protects the operation of pump 2130.

In one example, the solid material received in basket member 2300 are granules of activated carbon having a granule size that can be retained in material receiving portion 2310. As would be appreciated, the configuration and sizing of apertures 2313 may be varied as required depending on the type of material being used. Activated carbon can act as an effective treatment to remove chemical contaminants from drinking water and may be easily replaced once the carbon has lost its potency by removing basket member 2300 and replacing the activated carbon as required. In another example, the solid material may be vitamin or mineral supplements in dissolvable tablet or granular form to be dispersed or dissolved in the drinking water.

In terms of the introduction of additional material in liquid form, in one example the additional material may be a vitamin or mineral supplement in the form of liquid which can be introduced directly via housing inlet aperture 2118 as described above. In some circumstances, the contents of these liquid supplements may settle as sediment and in this case introducing the liquid supplement into the pumped water stream can assist in maintaining dispersal of these contents in the drinking water.

In another embodiment, water treatment apparatus includes a water heating capability. In one example, the water heating capability is configured as an electrical resistive heating element that may be deployed as plate or coil or other suitable geometry as required. In one example, a heating plate is placed in the gap between basket member 2300 and base portion 2160 and is powered by a power cord that is received into housing 2190 via housing aperture 2119. Heating the water can prevent drinking water in a water trough from freezing in cold conditions which improves accessibility to the water by animals in these conditions. In addition, heating of the water is likely to improve water consumption by animals which in turn assist with their overall health and condition. A further benefit of water heating is that raising the temperature of the drinking water will increase the amount of material, such as nutritional supplements, that may be dissolved in the water.

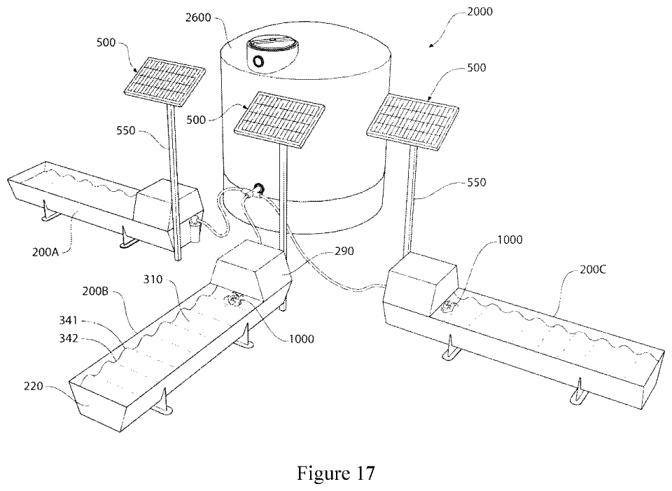

Referring now to FIG. 17, there is shown a livestock watering station 2000 comprising three drinking troughs 200A, 200B, 200C supplied by water source in the form of a tank 2600 supplied in this instance by an underground bore. Each drinking trough includes a water treatment apparatus 1000 which is configured to cause a continuing disturbance in a surface of the drinking water contained in the vessel as has been described above.

In this illustrative embodiment, water treatment apparatus 1000 is powered by a solar power module 500 as has been previously described which in this example is mounted on a support or post 550. As can be seen, the disturbance formed in the water surface 310 is in the form of an undulation that is a standing wave consisting of a regular series of peaks 341 and troughs 342 which functions to reduce the formation of algae. Furthermore, in this example, the bubbling action of the water treatment apparatus 1000 functions to further increase the oxygen content of the drinking water.

In another exemplary embodiment, a drinking vessel may be constructed with an integrated water treatment apparatus where the drinking water inlet takes a portion of water that is entering the drinking vessel from a water source such as a tank or the like and this water is then dispensed in a generally upwards direction from an outlet below the surface of the drinking water in order to cause a continuing disturbance in the surface of the water to treat the drinking water in the drinking vessel.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. An apparatus for the treatment of drinking water contained in a vessel, comprising:
a housing;
a drinking water inlet;
a drinking water outlet; and
a pump operable to pump drinking water from the water inlet to the water outlet, wherein the water outlet and pump are configured to dispense drinking water generally upwards from the water outlet below a surface of the drinking water to cause a continuing disturbance in a surface of the drinking water contained in the vessel.

2. The apparatus of claim 1, wherein in use the apparatus is submerged beneath the surface of the drinking water.

3. The apparatus of claim 1, wherein the continuing disturbance in the water surface is localised about the drinking water outlet.

4. The apparatus of claim 1, wherein the continuing disturbance in water surface is an undulation in the water surface formed substantially over the surface of the drinking water contained in the vessel.

5. The apparatus of claim 4, wherein the undulation in the water surface is a standing wave resulting from the interaction of the disturbance in the water surface and the boundary of the vessel.

6. The apparatus of claim 1, wherein the apparatus includes a filter to filter drinking water entering the drinking water inlet.

7. The apparatus of any claim 1, wherein the pump is a submersible electric pump.

8. The apparatus of claim 7, wherein the submersible electric pump is solar powered.

9. The apparatus of claim 1, wherein the apparatus is configured to be located on a floor section of the vessel.

10. The apparatus of claim 1, wherein the apparatus is integrated with the vessel.

11. The apparatus of claim 1, wherein the drinking water inlet of the water treatment apparatus receives water directly from the water source for the drinking vessel.

12. The apparatus of claim 1, wherein the drinking water contained in the vessel is treated to reduce algae.

13. The apparatus of claim 1, wherein the drinking water contained in the vessel is treated to increase its oxygen content.

14. The apparatus of claim 13, wherein the disturbance in the water surface breaks the surface tension of the water surface.

15. The apparatus of claim 13, further including a water aeration arrangement to increase the oxygen content of the drinking water dispensed from the drinking water outlet relative to the drinking water entering the drinking water inlet.

16. The apparatus of claim 15, wherein the water aeration arrangement includes a venturi fitting located between the drinking water inlet and the drinking water outlet.

17. A method for treating drinking water contained in a vessel, comprising:
pumping drinking water from the drinking water generally upwards from below a surface of the drinking water to cause a continuing disturbance in a surface of the drinking water contained in the vessel.

18. The method of claim 17, wherein the continuing disturbance in water surface is an undulation in the water surface formed substantially over the surface of the drinking water contained in the vessel.

19. The method of claim 18, wherein the undulation in the water surface is a standing wave resulting from the interaction of the disturbance in the water surface and the boundary of the vessel.

20. The method of claim 17, wherein the drinking water contained in the vessel is treated to reduce algae.

21. The method of claim 17, wherein the drinking water contained in the vessel is treated to increase its oxygen content.

22. The method of claim 21, wherein the disturbance in the water surface breaks the surface tension of the water surface.

23. The method of claim 21, further includes aerating the water to increase the oxygen content of the drinking water dispensed from the drinking water outlet relative to the drinking water entering the drinking water inlet.

24. A livestock watering station comprising:
a source of drinking water; and
one or more vessels connected to the source of drinking water, wherein the one or more vessels comprises the water treatment apparatus as claimed in claim 1.
